(19) United States
(12) Patent Application Publication
(10) Pub. No.: US 2010/0139194 A1
(43) Pub. Date: Jun. 10, 2010

(54) ROOF PANELING SYSTEM

(76) Inventor: Robert S. Burns, New Wilmington, PA (US)

Correspondence Address: JAMES R. WILLIAMS, 3103 WILMINGTON ROAD, NEW CASTLE, PA, 16105, US

(21) Appl. No.: 12/628,984

(22) Filed: Dec. 1, 2009

Related U.S. Application Data
(60) Provisional application No. 61/119,768, filed on Dec. 4, 2008.

(51) Int. Cl. E04D 1/20; E04D 3/24; E04C 2/26; B32B 19/02

(52) U.S. Cl. 52/309.6; 52/588.1; 52/309.17; 428/404; 428/406

(57) ABSTRACT

A roof paneling system includes a roof panel comprising an open-cell inorganic foam. The foam can decrease hydraulic conductivity of the roof paneling system, filter rainwater falling on the roof, and reflect excess heat. The open-cell inorganic foam preferably comprises a ceramic or glass, and has a porosity of at least about 20%, a mean pore size less than about 10 mm, and a thickness of at least about 10 mm. The foam can include a hydrophilic compound that further decreases the hydraulic conductivity of the foam. Optionally, the foam can have a reflectivity of at least about 20%.

The present invention claims priority to U.S. 61/119,768, which is hereby incorporated by reference.

### FIELD OF THE INVENTION

The present invention relates to roofing materials and a method for roof construction, and more particularly to a roof panel and a method for its installation.

### BACKGROUND OF THE INVENTION

Flat roof decks are popular in commercial buildings and typically are protected using an asphalt, built-up, or single-ply roof system. The built-up roof system can include a water-impermeable membrane, insulation, and a protective layer. The water-impermeable membrane prevents water from leaking through the roof deck, and can comprise at least one layer of substantially water-proof material such as, for example, roofing felt, bitumen sheets, and rubber membranes. Insulation can be placed below the roof deck on the interior of the building between rafters or any roof deck support. Insulation can also be placed above the roof deck, and can include a weather-resistant material such as, for example, cellular glass, fiber board, and plastic foams. A conventional installation positions the insulation between the roof deck and the membrane. The membrane is subject to temperature extremes that can degrade the membrane and cause roof system failure. Alternatively, the protected membrane roof (PMR) places the membrane beneath the insulation so that the membrane is thermally protected. A protective layer can be applied over the membrane and insulation. The protective layer can resist radiation, such as ultraviolet rays, mechanical wear and abrasion. The protective layer can include gravel, tiles, or sheets.

An alternative approach to roofing includes green roofing systems. Green roofing systems can comprise a water-impermeable membrane, a root barrier, a drainage system, a water-retaining substrate, and a vegetation layer. Depending on the grade of the roof deck, the drainage system can include for example a perforated, dimpled or corrugated plate, or a hydrophilic fabric blanket. Green roofing systems can extend the roof service life, reduce heating and cooling costs, utilize valuable commercial space, reduce runoff from roof surfaces, improve storm water retention and management, and increase property values. Unfortunately, green roofing systems are expensive (typically more than twice the cost of a traditional roof), typically require specially trained consultants, labor intensive to install and maintain, extremely heavy (at least about 15 pounds, that is about 6.8 kilograms, per square foot), need constant maintenance of the vegetation, often cannot be installed over existing roofing, and can be difficult to maintain and repair, such as, if a leak develops in the membrane. Modular or tray-type green roofing systems, such as U.S. Pat. No. 6,711,851 which is hereby incorporated by reference, have been proposed to facilitate roof repair.

### SUMMARY OF THE INVENTION

The invention includes a roof paneling system for roof construction. The roof paneling system can include a roof panel and preferably will include a plurality of roof panels. The roof panel can be used with, for example, a built-up roofing system particularly a protected membrane roof. The roof panel includes an open-cell inorganic foam. In aspects, the foam can decrease hydraulic conductivity or increase water retention of a roof paneling system. Besides moderating water run-off from a roof, the reduction in hydraulic conductivity can reduce roof temperature, filter rainwater falling on the roof, increase fire resistance, and reflect solar radiation.

The open-cell inorganic foam has a mean pore size that sufficiently decreases hydraulic conductivity so that the foam retains water and delays water runoff. Porosity of the open-cell inorganic foam can be at least about 20%. In embodiments, the mean pore size is less than about 10 mm and preferably less than about 1.0 mm. The open-cell foam should have a thickness sufficient to contain at least temporarily a pre-determined quantity of water. The thickness can be at least about 10 mm and preferably from about 50 to 250 mm.

The open-cell inorganic foam should be resistant to extreme weather conditions and ultraviolet radiation, and can include for example ceramics and glasses. Conveniently, the open-cell inorganic foam comprises silica, calcia, magnesia, alumina, and combinations thereof. In embodiments, the foam can include a hydrophilic compound either in the bulk of the foam or as a coating. The hydrophilic compound can further decrease the hydraulic conductivity and water retention of the foam. An abrasion resistant layer can be applied between the foam and a water-impermeable membrane. In embodiments, the abrasion resistant layer is applied to the bottom surface of the foam which will be in contact with the water-impermeable membrane.

The open-cell inorganic foam can be produced as roof panels having any convenient size. The roof panels can be placed over a water-impermeable membrane. Conveniently, the roof panels can be shaped to produce a flat exposed roof surface over an underlying sloped roof. The roof panels can reflect a portion of the sunlight that strikes the roof panels. Reflectivity will be at least about 20%, preferably at least about 50%, and more preferably at least about 70%.

### BRIEF DESCRIPTION OF THE DRAWINGS

FIG. 1 is a graph of temperature versus time showing the temperature rise of a roof comprising various roofing materials

FIG. 2 shows a graph of temperature versus time showing the benefit of a wet block over a dry block.

FIG. 3 shows a graph of water retention of various roofing systems, including the present invention.

FIG. 4 shows an embodiment of the present invention as part of a roofing system.

### DESCRIPTION OF THE PREFERRED EMBODIMENTS

The roof paneling system includes an open-cell inorganic foam. Advantages of the open-cell inorganic foam can include decreased hydraulic conductivity, retention of water, increased reflectivity, fire resistance, ease of installation, repair and inspection, physical and UV protection of the water-impermeable membrane, moderation of temperature extremes, and increased service life of the roof.

Built-up roofing systems can include a water-impermeable membrane covered by an abrasion resistant material. The abrasion resistant material can include gravel, pavers or tiles. The water absorption of these materials is typically less than one-tenth of one percent. These materials can, however, reflect at least a portion of sunlight from the roof. U.S. Pat. No. 6,487,830 to Robertson, which is hereby incorporated by reference, teaches a method of increasing reflectivity of a polymeric roofing membrane.

The open-cell inorganic foam will define a plurality of pores having a pore size and through which a fluid can pass. The pores can be regular or irregular in shape and distribution. For example, the pores can define a plurality of channels. The channels can extend from one surface of foam to another surface. The pores can form an interconnected network. The size of the pores will depend on the desired properties. Hydraulic conductivity will depend on the size, number, and shape of pore. The pores can include sizes that are conducive to capillary action. The extent of capillary action can affect hydraulic conductivity and the water retention.

Without intending to be bound by this explanation, capillary action is a significant force that enables materials to retain water and regulate its release. Although high porosity is typically correlated with a high hydraulic conductivity, that is, more open area is available for the flow of water, a small pore size can decrease hydraulic conductivity. Capillary action in the small pores resists flow of the water from the pore. Small pore size can even retain water in the open-cell inorganic foam. For example, clays can have very low hydraulic conductivity but are often very porous. This feature permits clays to hold large volumes of water per volume without releasing this water very quickly. In contrast, sands can include many large pores and hydraulic conductivity is high and water retention is typically low.

The porosity of the foam will be at least about 20%, preferably at least about 30%, and more preferably at least about 50%. The foam should retain sufficient strength for its intended purpose. In embodiments, the porosity of the foam will be less than about 80% and preferably less than about 70%. The pores can be of any convenient shape. In embodiments, the mean pore size is less than about 10 mm and preferably less than about 1.0 mm. Smaller pore sizes can decrease hydraulic conductivity, that is, the foam will retain water for a longer period of time. For very small pore sizes, water can be retained as a liquid essentially indefinitely. Pore size will depend on the desired water retention characteristics of the foam and other factors, such as, for example, the thickness of the foam, the pitch of the roof, the hydrophilicity of the material comprising the foam, and the shape of the pores.

Ponding is a technique used to reduce temperature of a roof. Ponding requires retention of some portion of water over the roof surface. U.S. Pat. No. 5,174,128 describes ponding and is hereby incorporated by reference. Judicious selection of pore size and number can retain water in the foam. Unlike ponding techniques that can permit water to remain on a roofing membrane, a foam can suspend the water above the membrane within the foam. Smaller pore size can more easily retain water in this fashion. In embodiments, an inorganic foam can include pore sizes with diameters of 0.5 mm to 1.5 mm. Alternatively, pore sizes can be up to 20 mm in diameter. Pore openings can be from about 50 microns to about 20 mm. An average pore opening is conveniently about 100 microns.

The bulk dimensions of the foam can also affect hydraulic conductivity. Thicker foams can hold more water and water will take longer to flow through thicker filters. The thickness of the foam can be increased by, for example, adding additional layers of foam. The open-cell foam should have a thickness sufficient to contain at least temporarily a pre-determined quantity of water. The thickness can be at least about 10 mm and preferably from about 50 to 250 mm. Cost and the need for physical strength can limit the thickness of the foam.

In embodiments, the roof paneling system can include a plurality of open-cell inorganic foam roof panels. The roof panels can form a continuous surface over the roof deck. In embodiments, each roof panel can include at least one edge that interlocks with an adjacent roof panel. The interlock can include a tongue and groove.

The roof panels can have different pore sizes and distributions. For example, the system can include a top layer, a middle layer, and a bottom layer adjacent to the roof deck. The top layer can include a large first pore size that permits rainwater to flow easily through the foam. The first pore size can be, for example, above about 1 mm. The middle layer can define a small second pore size in order to reduce hydraulic conductivity and increase water retention. The second pore size can be, for example, below about 1 mm. The bottom layer can be substantially non-porous so as to increase the mass of the system and resist damage from wind. One skilled in the art will appreciate various combinations of foams that could be beneficial in particular situations.

The foam can be of any shape. Conveniently, the foam will be of a shape that can form a continuous surface, such as, a triangle, rectangle or hexagon. The shape can have an edge that interlocks with adjacent shapes. The interlock can include, for example, an edge comprising tongue and groove.

The open-cell foam should be resistant to extreme weather conditions and ultraviolet radiation, and can include for example ceramics, clays, glasses, and combinations thereof. Conveniently, the open-cell inorganic foam comprises silica, calcia, magnesia, alumina, and combinations thereof.

In embodiments, the foam can include a hydrophilic compound either in the bulk of the foam or as a coating. The hydrophilic compound can further decrease the hydraulic conductivity of the foam or increase water retention. Examples of hydrophilic compounds can include a polymer such as a crosslinked polymer. An abrasion resistant layer can be applied between the foam and a roof membrane. In embodiments, the abrasion resistant layer is applied to a bottom surface of the foam that would be in contact with the roof membrane.

The foam can be placed on the roof and secured with any convenient mechanical fastener such as, for example, an adhesive, ballast, strap, or combinations thereof. Ballast can include covering the foam with rock or gravel. Alternatively, the foam can be secured to the roof by a grid. The grid can include straps over the foam or can secure the foam along its edges or bottom surface, that is, the side adjacent to the roof deck.

Other advantages of an open-cell, inorganic foam roof panel include filtration, fire resistance, low density, and ease of installation. For example, inorganic foams typically have low heat conductivities and are inherently non-flammable. These properties imbue the foam with fire resistance.

Although ponding can reduce heat on a roof surface, roof system manufacturers do not recommend ponding because ponding can deteriorate the roof membrane and can void the warranty. Tapered insulation boards can be used in combination with sloped roof decks to provide positive drainage and reduce ponding. Insulation boards are typically installed so that the top surface of the board is sloped downward toward the roof drain. The typical slope is 1/16 inch (0.1588 centimeter) to ½ inch (1.27 centimeters) drop per lineal foot. When the waterproof roofing membrane is installed on top of insulation, the top surface of the roof assembly sheds water toward the drain, thereby avoiding ponding. Of course, the resultant roof surface is not flat.

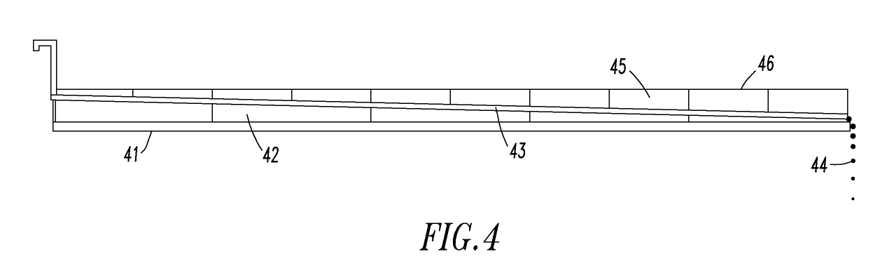

A flat exterior roof surface can be produced by setting paver stones on the sloped roof membrane surface. The installation typically involves placing the paver stones on pedestals, but the process is tedious as each paver stone must be adjusted on each paver to achieve a level surface. The pedestals are necessary because pavers resting directly on the roof membrane could restrict the flow of water to a drain and would not provide a level surface. The present invention can be used more easily in combination with a sloped roof membrane surface to produce a flat exterior roof surface. The open-cell inorganic foam can be manufactured with a reverse taper corresponding to the slope of the top surface of the roof membrane. The foam can be placed directly on the roof membrane without the need for pedestals. In one embodiment, as shown in FIG. 4, a roofing system comprises a roof deck 41, a layer of insulation 42, a roof membrane 43, and a plurality of tapered inorganic foam panels 45. The combination produces a flat exterior roof surface 46 that still permits water to flow towards a drain 44.

For example, standard tapered panels can be manufactured to match inversely standard tapered insulation boards, which are used in the industry. One such insulation board has a ¼ inch (0.635 centimeter) taper. A foam panel could be 2′×2′ with a slope of ¼ inch (0.635 centimeter) per foot. One edge of the panel would be ½ inch (1.27 centimeters) thicker than the preceding edge. Prior art panels with pedestals are typically very rigid and hard. Such panels are difficult to cut on the job site and special cutting tools may be necessary for installation. The present invention comprises an open-cell inorganic foam is easy to cut with standard hand tools to produce a flat top surface of a roof.

Of course, inorganic foam panels can also be custom manufactured to meet unique roof requirements. This can also be accomplished off-site at a manufacturing facility instead of on-site on the roof. New manufactured roofing systems can include tapered insulation maps showing where each piece of insulation should be installed. Drawings can show where each water-retaining, open-cell inorganic roof panel should be installed. The result can be a level roof top to be used, for example, as a recreational surface.

A level surface as described above would reduce ponding water because the roof membrane would direct water to the drain unimpeded by the foam roof panels and because the pores of the inorganic foam tend to draw water into themselves due to capillary action. The present invention combines the previously competing properties of providing a level surface, reducing ponding, reducing storm water runoff, and increasing water retention.

In still further embodiments, the present invention can include inorganic foam in shapes and sizes similar to gravel, which is typically used in roof construction. The size of the chunks or man-made stones could vary. The preferable size would be about ¾ inch (about 1.905 centimeters) to 6 inch (15.24 centimeters). An advantage of this application is the speed and consequential labor cost savings of the installation process. Roof mechanics know how to apply gravel to a roof and the roofing equipment that is currently used for applying gravel can be also be used to apply inorganic foam gravel without adaptation.

Inorganic foam gravel can also be used in combination with inorganic foam blocks, concrete paver stones or other roof coverings. The light weight of foam gravel could limit its use in areas where wind resistance is of high concern, such as the perimeter of a roof. Of course, water will increase the weight of the foam gravel and the gravel's wind resistance will increase. For example, 6 pounds (2.722 kilograms) of foam gravel can replace 12 pounds (5.443 kilograms) of river wash gravel because the added water weight will increase the overall weight of the foam ballast to 12-18 pounds (5.443 kg-8.165 kg). The combined weight of the inorganic foam and the water can permit the foam to be placed on the roof without a need for a mechanical fastener. The combined weight, whether embodied as a foam gravel or a foam panel, can replace the ballast of ballasted roof systems. In embodiments, the weight of the dry foam can be sufficient ballast.

The inorganic foam of the present invention can be used in combination with other roofing materials. For example, high traffic areas can include concrete pavers or boards over the inorganic foam. High wind areas can include additional ballast, such as concrete board or gravel. In still another embodiment a protective coating can be applied to the underside of the foam panel over the waterproofing membrane so that the foam does not damage the roof membrane.

### Example 1

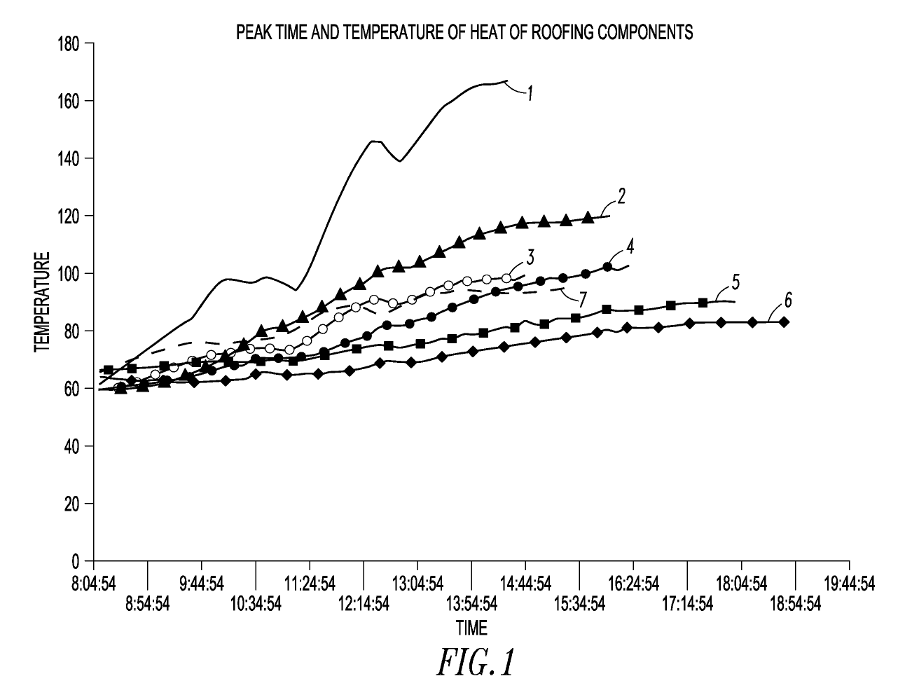

Temperature was measured over time for a number of different roof systems as shown in FIG. 1, including black EPDM sheet 1, a light colored ballast material 2, a reflective white coating 3, a white paver 4, a growing medium 5, and a wet foam 6 of the present invention. For comparison, the ambient air temperature 7 is also provided. As expected, the black EPDM sheet 1 absorbed heat energy and had had a peak temperature over 170 F. A light colored ballast 2 reduced the maximum temperature to only about 120 F, which was still about 25 F above ambient air temperature. Growing medium 5 kept the roof below ambient temperature, but the growing medium adds significant weight to the roof. Wet foam 6 of the present invention held temperature well below ambient temperature and even below that of growing medium 5. Advantageously, wet foam 6 accomplishes this without adding significant weight. Reducing temperature can significantly reduce cooling demand and electrical power requirements.

### Example 2

Two identical open-cell, inorganic foams were placed on top of water-impermeable membranes. The membranes comprised EPDM rubber. One foam was saturated with water. The other foam was left dry. Both foams were exposed to solar radiation and the temperatures at the foam-membrane interface were measured. A roof membrane without foam was used as a control. Without either foam, the membrane reached over 160 F in 15 minutes. The interface of the wet foam reached only 82 F. The interface of the dry foam reached 102 F. Wet or dry, the foam significantly reduced the temperature of the roof membrane.

### Example 3

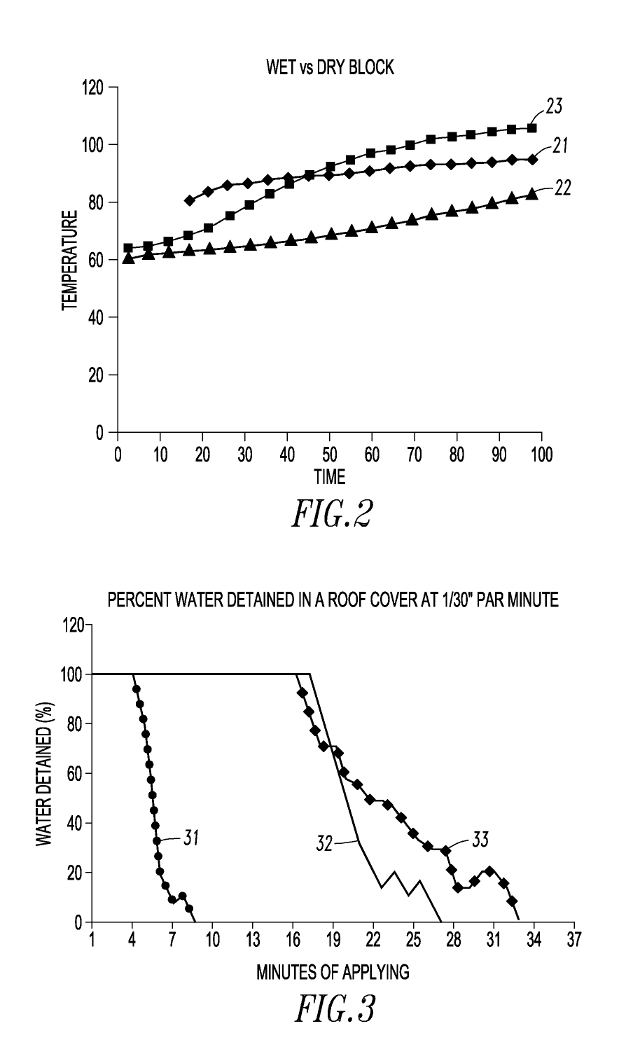

The insulation effect of a wet foam was compared to that of a dry foam. Two open-cell inorganic foam blocks were placed 50 cm from a radiant heat source. A first block was dry, and a second block was saturated with water. A control measured the temperature without any block at a location equidistant from the heat source to the underside of the blocks. FIG. 2 shows temperature versus time for the ambient temperature 21, the temperature of the underside of the wet block 22, and the temperature of the underside of the dry block 23. The dry block heated up quickly. The wet block heated up significantly more slowly.

### Example 4

A vegetative roof covering included a membrane protecting layer, a drainage layer, a root barrier, growing media, and vegetation. The growing media was 3 inches (7.62 centimeters). The vegetative roof system had a dry weight of about 14 pounds (about 6.35 kilograms) per square foot. Water was poured onto the roof until the roof covering was saturated. At saturation, the roof covering absorbed nearly 6 pounds (2.722 kilograms) of water or about 43% of its dry weight. The weight of the saturated vegetative roof covering was therefore about 20 pounds (about 9.072 kilograms) per square foot.

Twenty four foam blocks of the present invention were weighed. The blocks were dry and weighed less than 2.8 pounds (1.27 kilograms) per square foot. Six pounds (2.722 kilograms) of water, which was the amount required to saturate the vegetative roof, were poured onto the blocks. The blocks absorbed this amount of water, which represents over 200% of their weight in water. The wet foam blocks weighed only 8.8 pounds (3.992 kilograms), or less than half that of the saturated vegetative roof. Reduced weight reduces the structural load and building costs.

### Example 5

The benefit of storm water runoff was measured by applying 1/30 inch (0.08467 centimeter) of water to a roof covering system every minute for 60 consecutive minutes. This represents a 2 inch (5.08 centimeters) per hour rain event. Three roof coverings were tested, including a standard 2B river washed gravel applied at 12 pounds (5.443 kilograms) per square foot, vegetative growing media with a drainage layer where the growing media was applied at 16 pounds (7.257 kilograms) per square foot, and the present inventive inorganic foam applied at a rate of 3 pounds (1.361 kilograms) per square foot. The results of the test are shown in FIG. 3. The gravel roof 31 saturated in about 5 minutes, the growing medium 32 saturated in about 19 minutes, and a foam 33 of the present invention saturated in about 20 minutes.

While specific embodiments have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the method described herein, which is to be given the full breadth of the appended claims and any and all equivalents thereof.

What is claimed is:

1. A roof paneling system that decreases hydraulic conductivity from a roof deck comprising a roof panel comprising an open-cell inorganic foam defining a plurality of pores through which a fluid can pass, the open-cell inorganic foam having a porosity of at least about 20%, a thickness of at least about 10 mm, and comprising a material selected from a group consisting of ceramic, clay, glass, and combinations thereof.

2. The roof paneling system of claim 1, wherein the open-cell inorganic foam comprises silica, calcia, magnesia, alumina, and combinations thereof.

3. The roof paneling system of claim 1, wherein the open-cell inorganic foam includes a hydrophilic compound

4. The roof paneling system of claim 1, wherein the open-cell inorganic foam has a reflectivity of at least about 20%.

5. The roof paneling system of claim 1, wherein the plurality of pores have a mean pore size less than about 10 mm.

6. The roof paneling system of claim 1, wherein the plurality of pores have a mean pore size less than about 1.0 mm.

7. The roof paneling system of claim 1, wherein the plurality of pores define pore openings from about 50 microns to about 20 mm.

8. The roof paneling system of claim 1, wherein the plurality of pores define a plurality of channels.

9. The roof paneling system of claim 1, wherein the plurality of pores define an interconnected network.

10. The roof paneling system of claim 1, wherein the porosity of the open-cell inorganic foam is at least about 50%.

11. The roof paneling system of claim 1, wherein the roof paneling system includes a top layer having a first pore size greater than 1 mm, a middle layer having a second pore size less than 1 mm, and a bottom layer that is essentially non-porous and adjacent to the roof deck

12. The roof paneling system of claim 1, wherein the roof paneling system includes a plurality of roof panels that form a continuous surface, each roof panel comprising an edge that interlocks with an adjacent roof panel.

13. The roof paneling system of claim 12, wherein the edges interlock with a tongue and groove.

14. The roof paneling system of claim 1, wherein the roof paneling system includes an abrasion resistant layer between the roof panel and the roof deck.

15. A roof paneling system that decreases hydraulic conductivity from a roof deck comprising a plurality of roof panels, the roof panels comprising an open-cell inorganic foam defining a plurality of pores through which a fluid can pass, the open-cell inorganic foam having a porosity of at least about 20%, a thickness of at least about 10 mm, and comprising a material selected from a group consisting of ceramic, clay, glass, and their combinations, the roof panels secured on the roof deck by a mechanical fastener selected from a group consisting of an adhesive, ballast, strap, or combinations thereof.

16. The roof paneling system of claim 15, wherein the roof deck includes a taper and the roof panels include a reverse taper to produce a flat exterior roof surface.

17. The roof paneling system of claim 15, wherein the roof paneling system comprises a protective coating between the roof panels and the roof deck.

18. A gravel for a roof deck capable of reducing hydraulic conductivity comprising an open-cell inorganic foam defining a plurality of pores through which a fluid can pass, the open-cell inorganic foam having a porosity of at least about 20%, and comprising a material selected from a group consisting of ceramic, clay, glass, and their combinations.

19. The gravel of claim 18, wherein the gravel includes a size up to about 6 inches (about 15.24 centimeters).

20. The gravel of claim 18, wherein the plurality of pores have a mean pore size less than about 10 mm.
